(19) United States
(12) Patent Application Publication
(10) Pub. No.: US 2015/0075674 A1
(43) Pub. Date: Mar. 19, 2015

(54) Apparatus for Forming Dovetail and Box Joints

(71) Applicant: John Ethan Chapman, Elgin, IA (US)

(72) Inventor: John Ethan Chapman, Elgin, IA (US)

(21) Appl. No.: 14/469,996

(22) Filed: Aug. 27, 2014

Related U.S. Application Data
(60) Provisional application No. 61/959,527, filed on Aug. 27, 2013.

(51) Int. Cl. B27F 1/12; B27C 5/10

(52) U.S. Cl. CPC B27F 1/12; B27C 5/10
USPC 144/144.52; 144/144.51

(57) ABSTRACT

A device for guiding a router bit in the cutting of pins and tails during the formation of dovetail joints, box joints, and other similar types of joints. The device comprises a base which is adapted to be removably combined with a template and may be transparent. The template has a tail side and a pin side. The tail side comprises a plurality of spaced parallel notches adapted to guide a router having an angled tail bit along the workpiece to create the tails. The pin side has a plurality of notches with sides angled such that each notch is wider toward the bottom of the notch (away from the edge of the template).

This application is based upon U.S. Provisional Application Ser. No. 61/959,527 filed Aug. 27, 2013, the complete disclosure of which is hereby expressly incorporated by this reference.

### BACKGROUND

Dovetail joints are considered to be the hallmark of a master woodworker who has acquired a significant level of skill. Dovetail joints are also a mark of quality and attention to detail that many people look for in high-quality furniture. This is because a dovetail joint requires very accurate and consistent workmanship in order to fit together properly. However, creating tight-fitting, accurate dovetail joints requires skill and patience sometimes beyond the amateur woodworker. Existing templates/jigs for creating dovetail joints are expensive and difficult for the amateur woodworker to use.

One difficulty in cutting dovetails using existing templates is centering the wood workpiece on the template to ensure the ends are even. It is desirable to center the edges of the workpiece behind portions of the jig during the cutting operation. However, existing jigs are made of opaque materials such as metal thereby limiting the woodworker's ability to see the ends of the workpiece behind the jig.

Another difficulty in cutting dovetails joints using existing templates is that significant care must be taken to ensure the correct side of the wood workpiece is facing the template. If the workpiece is facing the wrong direction then the angles of the cuts will be backwards resulting in a workpiece that does not fit properly with the adjoining wood workpiece. Existing dovetail jigs require opposite sides of the workpiece to be facing the template when cutting the pins and tails in the wood workpiece. The action of flipping the workpiece over when making these two cuts often results in confusion and mistakes since it can be difficult to keep track of which side of the wood should be facing the template for which particular cut.

Thus, there is a need for an improved device which simplifies the creation of dovetail and other types of joints for woodworkers.

### SUMMARY

The present invention comprises a device for assisting with the formation of dovetail joints, box joints, and other similar types of joints with a router. The device comprises a base which is adapted, to be removably combined with a jig/template. In one embodiment the template is transparent thereby allowing the user to see the wood workpiece through the template. The template has a tail side and a pin side. The tail side comprises a plurality of spaced parallel notches adapted to guide a router having an angled tail bit along the workpiece to create the tails. The pin side has a plurality of notches with sides angled such that each notch is wider toward the bottom of the notch (away from the edge of the template). The shape of the pin side notches allows a wood workpiece to face the same direction during the cutting of the pins and the tails. The pin side is adapted to guide a router having a straight bit along the workpiece to create the pins.

### BRIEF DESCRIPTION OF THE DRAWINGS

FIG. 1 is a perspective view of the base;

FIG. 2 is a perspective view of the base combined with the template;

FIG. 3 is a top view of the template; and

FIG. 4 is a perspective view of the tail side of the device aligned with a wood workpiece.

### DETAILED DESCRIPTION

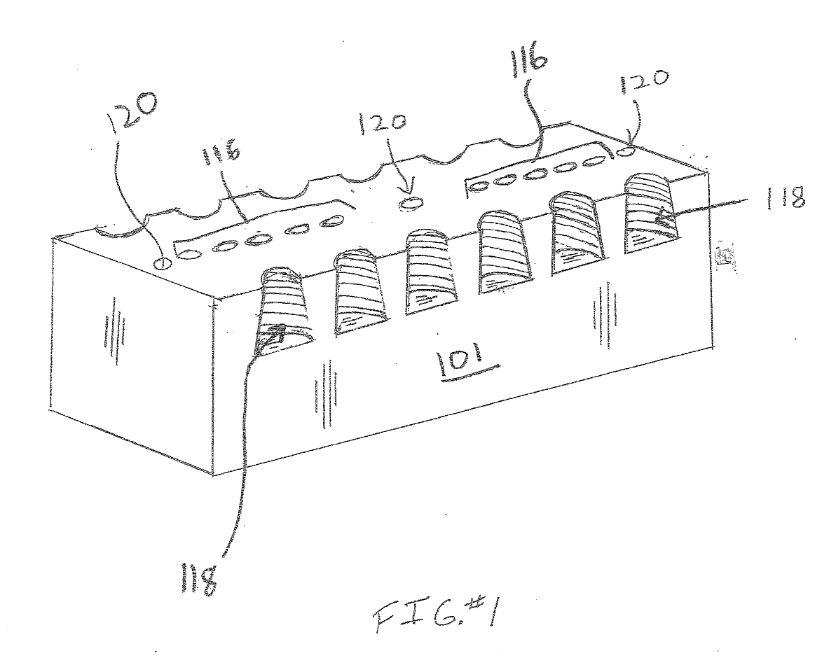

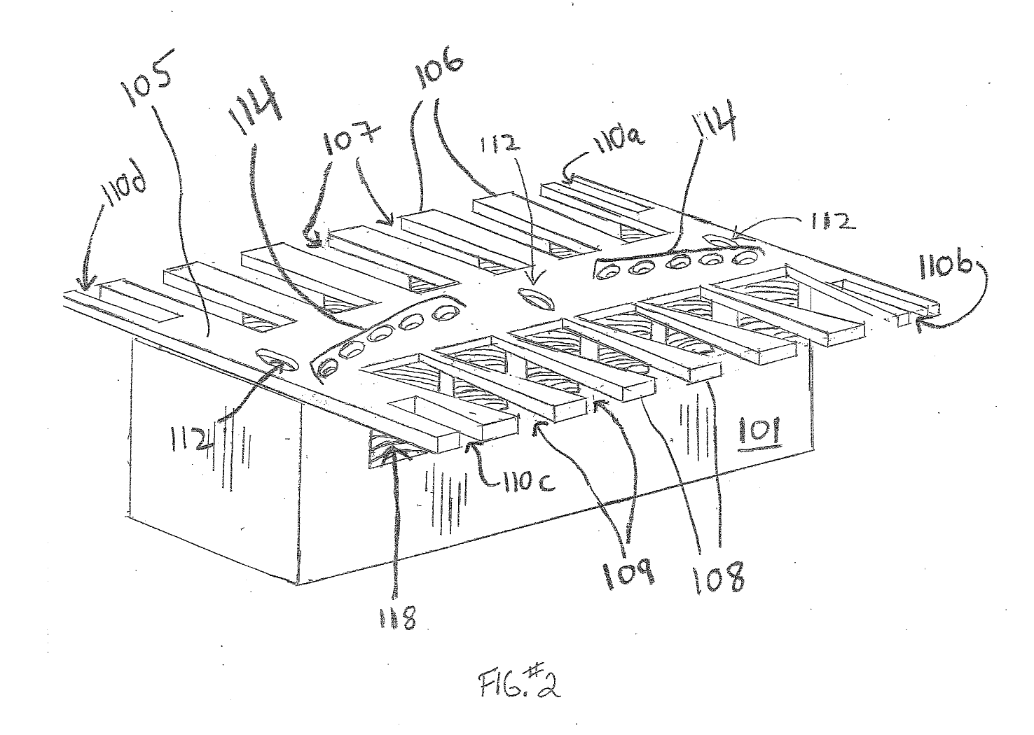

The present invention, consisting of multiple embodiments and described more fully below, comprises a device which acts as a guide for a router bit to cut pins and tails on the edges of boards so the workpieces can be connected by a dovetail joint, a box joint, or other similar types of joints. As shown in FIGS. 1-4, the device comprises a base 101 which is adapted to be removably combined with a jig/template 105. The base 101 provides support for the template 105 and contains significant surface area on which to clamp the device to the wood workpiece 130. The device may be adjusted so as to accommodate differing thicknesses of the workpieces 130. In one embodiment, the base 101 is a generally rectangular block. The base is sufficient in diameter to allow enough surface area to permit a clamping device to firmly secure the workpiece 130 to help prevent inadvertent movement. A commercially available clamp (not shown) of appropriate size is used to squeeze the workpiece 130 firmly against the base 101. The base 101 may include notched recesses 118 along one or two of its sides. As shown in FIG. 2, these recesses 118 correspond to the area directly behind the notches 107, 109 in the template 105 to help prevent contact between the router bit and the base 101 during cutting operations. The base 101 also includes a row of openings 116, 120 along its top surface which are adapted to receive fasteners, such as screws. The openings 116, 120 are further describe below with reference to the adjustment means feature.

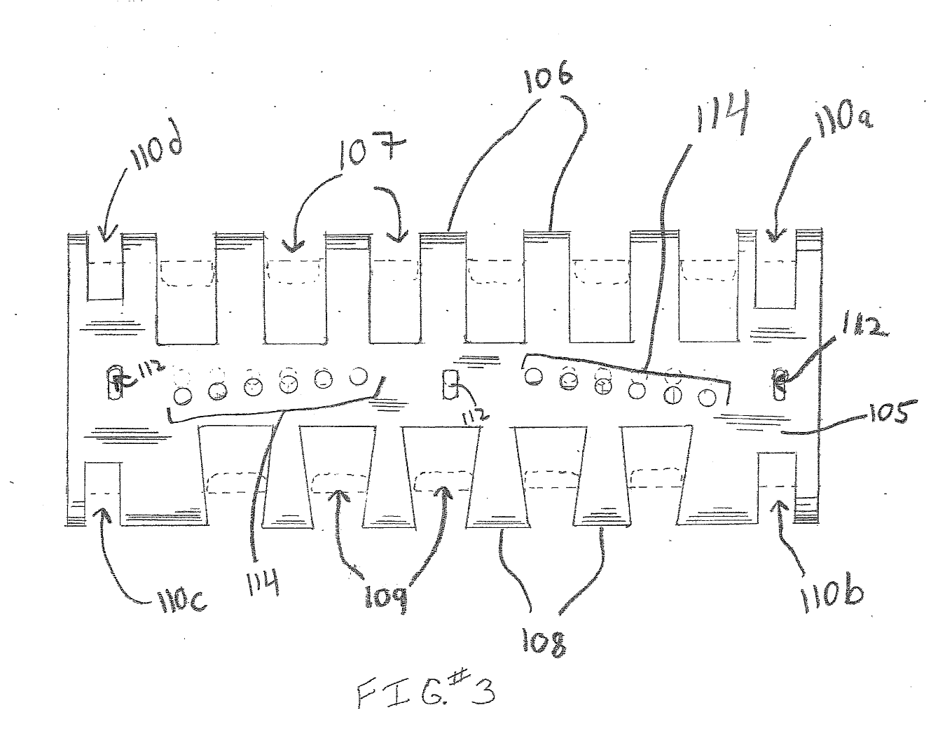

As shown best in FIG. 3, the template has a tail side 106 and a pin side 108. The tail side 106 comprises a plurality of spaced parallel notches 107 adapted to guide a router having an angled tail bit along a workpiece 130 to create the tails. In one embodiment, the notches 107 have sides which are generally parallel to each other, such as a square or rectangular shape. The pin side 108 has a plurality of notches 109 with sides angled such that each notch is wider toward the bottom of the notch 109 (away from the edge of the template 105). In one embodiment, the sides of each notch 109 angle outward toward the sides of the device (starting at the edge 108) at between about 5-10 degrees. In one embodiment the sides angle outward at about 7 degrees. The pin side 108 is adapted to guide a router having a straight bit along the workpiece 130 to create the pins. The shape of the pin side 108 notches 109 (being wider at the bottom) allows the same side of the wood workpiece 130 to face the template 105 during the cutting of the pins and the cutting of tails.

As shown best in FIG. 3, one embodiment includes an adjustment means for adjusting the position of the template 105 relative to the base 101. The adjustment means allows the user to adjust the size of the pins by changing the amount of material removed from the workpiece 130 with the router. The user adjusts the position of the template 105 for the thickness of the wood workpiece 130. The base 101 contains a generally straight row of spaced openings 116 along the length of its top surface. The template 105 contains a row of spaced openings 114 diagonally aligned (angled relative to the length of the template 105), each of the openings 114 in the template 105 is adapted to correspond to one of the openings 116 in the base 101. The openings 114, 116 are adapted to receive a fastener such as a screw to help secure the template 105 to the, base 101. A fastener is only inserted through one pair of openings 114, 116 at a time. Changing the pair of openings 114, 116 used will change the position of the template 105 relative to the base 101. For example, inserting a fastener through the openings 114, 116 nearer to the end of the template 105/base 101 will cause the pin side 108 of the template 105 to be closer to the base 101 while inserting a fastener through the openings 114, 116 nearer to the middle of the template 105/base 101 will cause the pin side 108 of the template 105 to be farther from the base 101. This ability to adjust allows for accommodation of varying thickness of the workpieces 130. To accommodate for a thicker workpiece 130, the edge of the pin side 108 is positioned farther from the base 101. To accommodate for a thinner workpiece 130, the edge of the pin side 108 is positioned closer to the base 101. As described in more detail below, the farther the edge of the pin side 108 is from the base 101 (by using the opening 114 closer to the middle), the looser the fit between the pins and tails because more material is removed from the pins created in the wood workpiece 130. More material is removed because the router is allowed to cut farther into the wider portion of the notch 109. In one embodiment, the template 105 includes visual indicators above each opening 114 to help the user determine which opening 114 should be used for a particular thickness of wood. As shown in FIG. 3, there may be two opposing sets of openings 114, 116 on the template 105 and base 101 to help secure the template 105 in place relative to the base 101. Further, the angle of the openings 114 may be reversed such that the opening nearest to the outer edge of the template 105 is farthest from the pin side 108. Also, the openings 114 on the template may be aligned in a straight line and the openings 116 on the base 101 may be angled to obtain the same adjustment means.

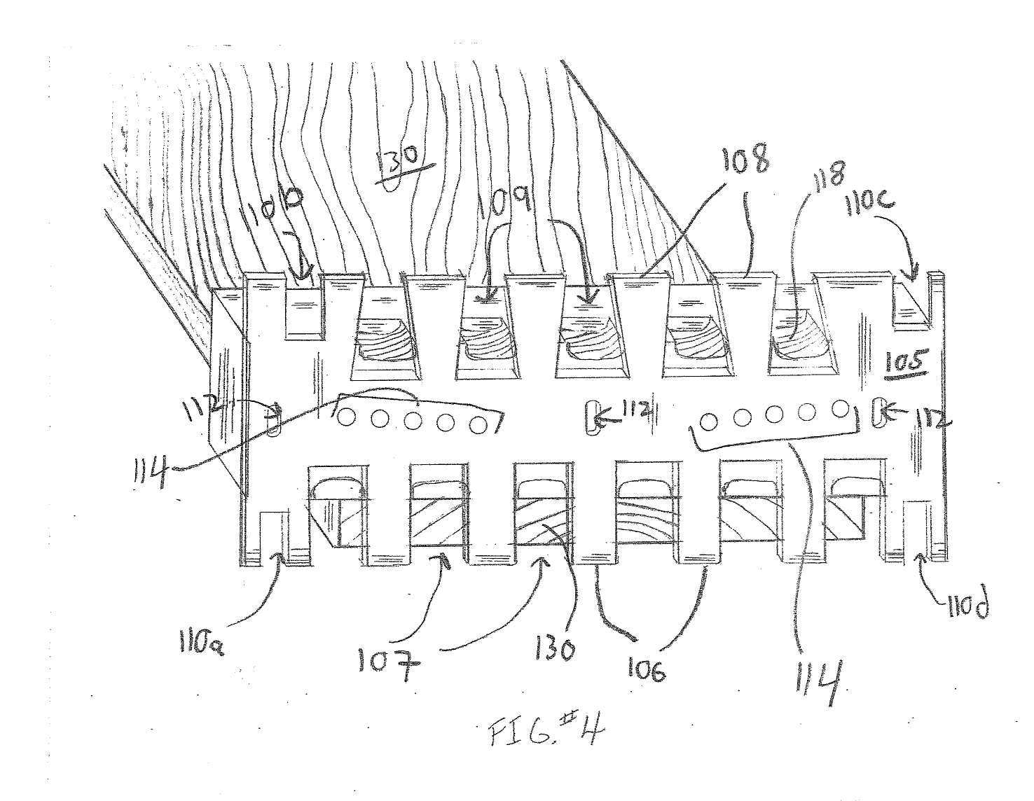

In one embodiment the template 105 is transparent thereby allowing the user to see the wood working piece through the template. To allow transparency, the template 105 may be made of any suitable material, including acrylic. The transparent template 105 helps with alignment of the wood workpiece 130 during the cutting operation. As shown in FIG. 4, the wood is secured behind the template 105. With existing opaque templates it is only possible to see the portions of the wood which appear in the notches 107, 109. FIG. 4 shows the workpiece 130 centered such that its ends are visible through the notches 107, however, it is often desirable to center the outer edges of the wood under the portions of the template 105 which separate and define the notches 107, 109. The transparency of the template 105 allows the user to more easily align the edges of the wood even when the wood is behind the template 105.

In one embodiment the template 105 includes at least one notch 110a-110d which functions as a router bit depth guide. The distance the router bit extends from the router is varied depending on the thickness of the workpiece 130. The notches 110a-110d are different lengths measured from the outer edge of the template 105 to the bottom of each notch 110a-110d. In use, a user inserts the bit into the appropriate notch 110a-110d to determine the appropriate distance that the bit should extend from the router. In one embodiment, the notches 110a-110d are labeled with visual indicators to allow users to quickly and easily determine the proper router depth for a given thickness of wood.

In use, the base 101 is secured to the template 105 in the desired position depending on the thickness of the workpiece 130. The user may user the router bit depth guide to determine the proper length the bit should extend from the router. The wood workpiece 130 is secured behind the tail side 106 and a router with an angled tail bit is used to cut the tails by following the pattern created by the notches 107. The workpiece 130 is removed from the tail side 106 and similarly secured behind the pin side 108 with the same side facing the template 105. The user then uses a router with a straight bit to create the pins by following the pattern created by the notches 109. If the pins and tails do not fit together properly, for example, if the fit is too tight or too loose, then the user may adjust the position of the template 105 relative to the base 101 to cause the pins to be larger or smaller, as desired. For example, if the fit is too tight, the user can use the adjustment means to move the pin side 108 farther away from the base 101 to create larger openings between the pins.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. A device for creating a joint between a first workpiece and a second workpiece, said device comprising:
a template having a tail side, a pin side, and a center;
wherein the tail side has an edge and a plurality of spaced notches with generally parallel sides extending from the tail side edge toward the center of the template;
wherein the pin side has an edge and a plurality of spaced notches with angled sides extending from the pin side edge toward the center of the template wherein the pin side notches are wider toward the center of the template then they are toward the pin side edge.

2. The device of claim 1 wherein the template is transparent.

3. The template of claim 1 wherein the template further comprises a router bit depth guide.

4. The template of claim 1 wherein the sides of the pin side are angle at between about 5-10 degrees.

5. A device for creating a joint between a first workpiece and a second workpiece, said device comprising:
a base;
a template removably combined with the base, wherein the template has a tail side and a pin side;
wherein the tail side has an edge and a plurality of spaced notches with generally parallel sides extending from the tail side edge toward the center of the template;
wherein the pin side has an edge and a plurality of spaced notches with angled sides extending from the pin side edge toward the center of the template wherein the pin side notches are wider toward the center of the template then they are toward the pin side edge.

6. The device of claim 5 wherein the template is transparent.

7. The device of claim 5 wherein the base and the template each have a length and the base comprises a plurality of spaced openings aligned in an generally straight line along the length of the base;
wherein the template comprises a plurality of spaced openings aligned at an angle relative to the length of the template;
wherein the openings in the base and the openings in the template are each adapted to receive a fastener for securing the template to the base.

8. The device of claim 5 wherein the joint is a dovetail joint.

9. The device of claim 5 wherein the joint is a box joint.

10. The template of claim 5 wherein the template further comprises a router bit depth guide.

11. The device of claim 5 wherein the base further comprises notched recesses to help prevent contact between the router bit and the base during cutting operations.

12. A device for helping to create a joint between a first workpiece and a second workpiece, said device comprising:
a base;
a transparent template removably combined with the base, wherein the template has a tail side and a pin side;
wherein the tail side has an edge and a plurality of spaced notches with generally parallel sides extending from the tail side edge toward the center of the template;
wherein the pin side has an edge and a plurality of spaced notches with angled sides extending from the pin side edge toward the center of the template wherein the pin side notches are wider toward the center of the template then they are toward the pin side edge;
wherein the base has a plurality of spaced openings aligned in an generally straight line along the length of the base;
wherein the template has a plurality of spaced openings aligned at an angle relative to the length of the template;
wherein the openings in the base and the openings in the template are each adapted to receive a fastener for securing the template to the base.

13. The template of claim 12 wherein the template further comprises a router bit depth guide.

14. The template of claim 12 wherein the sides of the pin side are angle at between about 5-10 degrees.
